(19) United States
(12) Patent Application Publication
(10) Pub. No.: US 2007/0200683 A1
(43) Pub. Date: Aug. 30, 2007

(54) SYSTEM AND METHOD FOR GENERATING ORDERS

(76) Inventor: Steven M. Colby, Mountain Vew, CA (US)

Correspondence Address: STEVEN M. COLBY, P. O. BOX 52033, PALO ALTO, CA, 94303, US

(21) Appl. No.: 11/382,264

(22) Filed: May 8, 2006

Related U.S. Application Data
(60) Provisional application No. 60/678,428, filed on May 6, 2005.
(60) Provisional application No. 60/685,331, filed on May 27, 2005.
(60) Provisional application No. 60/700,884, filed on Jul. 19, 2005.
(60) Provisional application No. 60/712,308, filed on Aug. 30, 2005.
(60) Provisional application No. 60/715,641, filed on Sep. 10, 2005.
(60) Provisional application No. 60/752,933, filed on Dec. 21, 2005.
(60) Provisional application No. 60/758,751, filed on Jan. 13, 2006.
(60) Provisional application No. 60/782,068, filed on Mar. 13, 2006.
(60) Provisional application No. 60/744,154, filed on Apr. 3, 2006.
(60) Provisional application No. 60/746,636, filed on May 6, 2006.

(51) Int. Cl. H04Q 5/22

(52) U.S. Cl. 340/10.51; 340/5.41; 340/10.34; 340/5.9; 705/26

(57) ABSTRACT

An automated ordering system for consumables, equipment maintenance supplies, and the like. The present invention uniquely combines the features of instrument maintenance and sample tracking systems with unique e-commerce and order generation systems. In doing so it provides unique advantages to both vendors and users. An aspect of the present invention is “permission purchasing” in which, through the use of the system, a user is supplied with all the parts and services needed to maintain a piece of equipment. In some embodiments, orders are generated using a data set with information specific to a particular instrument and responsive to the usage of the instrument. The system optionally makes use of computer networks such as the Internet.

### CROSS-REFERENCE TO RELATED APPLICATIONS

This application claims benefit and priority to U.S. provisional patent applications: 60/678,428 filed May 6, 2005; 60/685,331 filed May 27, 2005, 60/700,884 filed Jul. 19, 2005; 60/712,308 filed Aug. 30, 2005; 60/715,641 filed Sep. 10, 2005; 60/752,933 filed Dec. 21, 2005; 60/758,751 filed Jan. 13, 2006; 60/782,068 filed Mar. 13, 2006; 60/744,154 filed Apr. 3, 2006, and 60/746,636 filed May 6, 2006. The disclosures of the above provisional patent applications are hereby incorporated herein by reference.

The disclosure of U.S. nonprovisional patent application Ser. No. 11/350,309 filed Feb. 7, 2006 is hereby incorporated herein by reference. The disclosure of U.S. nonprovisional patent application Ser. No. 11/382,050 filed May 7, 2006 is hereby incorporated herein by reference.

### BACKGROUND OF THE INVENTION

1. Field of the Invention

The invention is in the field of financial transactions and, according to some embodiments, in the field of automated order generation.

2. Related Art

Some inventory systems automatically generate orders when inventory reaches a specific level. This approach requires that inventory be carefully counted.

### SUMMARY

Orders are automatically generated based on use of an instrument or other system that consumes inventory. The present invention provides part numbers, vendor, and ordering information for needed parts and supplies and optionally automatically generates purchase orders and/or places electronic orders. In various embodiments advantages achieved by the present invention include: providing improved and more regular maintenance of instruments; providing greater convenience and time savings to the user; and/or automatic generation of orders for needed materials. Some embodiments include an advantage of enabling of “Permission Sales” wherein a supplier-customer relationship is established that allows a vendor to ship products to a customer with minimal effort on the part of the customer. The above advantages are illustrative. Various embodiments of the present invention optionally include other advantages and achieve to varying degrees, none, some or all of these specific advantages.

### DETAILED DESCRIPTION

The present invention includes server-side computer programs and EMWiz™ (Equipment Maintenance Wizard), a downloadable utility that tracks the use and maintenance requirements of instruments. EMWiz and the server-side programs embody several levels of sophistication and a variety of feature sets. These are illustrated by several illustrative embodiments discussed herein. The features discussed may be interchangeable, between the specific embodiments shown, in order to form additional embodiments.

Elements of the present invention that are shared by several embodiments include the following: the ability to notify the user of future, current, and past due maintenance requirements for a piece or set of equipment; the ability to either read files or receive manually entered maintenance data that applies to specific equipment; the ability to monitor instrument use; and/or the ability to provide users with part numbers and/or ordering information for replacement supplies and service.

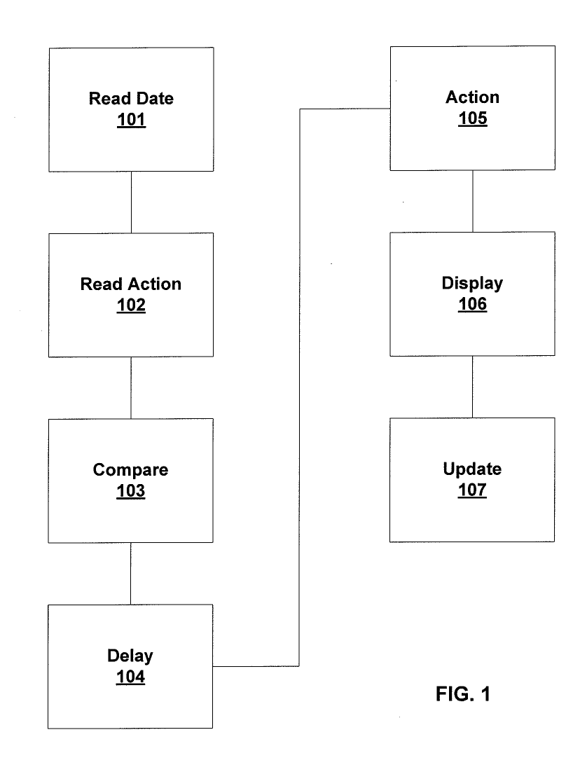

Several embodiments of the present invention include a software program capable of executing the method illustrated in FIG. 1. In a read date step 101 the software reads the system date. This information is available through most computer operating systems. In a read action step 102 the software reads data indicating the next time some program action must be taken (the “action date”). In some embodiments the order of these two steps is reversed. The action date is optionally read from a file or may be imbedded as part of the software program. In a compare step 103 the current data is compared with the action date. The “dates” used by the current invention may include a specific format such as Julian or calendar date and/or time of day information. If the next action date is after (or perhaps equal to) the current date an optional delay step 104 is initiated. After delay step 104 the method returns again to step 101. If, after step 103, the next action date is found to be prior to the current date, then an action step 105 is performed. Action step 105 includes collection of information needed to perform an action. The information is optionally included with the action date data. This information may include the action that is needed, part numbers of any materials required and information on ordering these materials. The software program of the invention is differentiated from other reminder or calendar programs in that either part numbers and/or ordering information is provided to the user, optionally responsive to an instrument associated with the software program. This provides a great advantage and convenience to the user. It is also to the great advantage of the vender whose ordering information is displayed. Action information is then displayed to the user (106). Finally the action data is updated appropriately (107). This update will make the date of the another action the “next action date” if appropriate. Finally, the process will return to either step 101 or 104.

Several of these steps may be performed in an order other than that shown in FIG. 1. For example, step 107 may be performed before steps 105 or 106 without substantially altering the means or the result of the process.

Note also that the use of date information is used to measure the time delay between action items. Other forms of measurement may be used. For example, a counting system may alternatively be used. In this case the number of times some event occurs will be a measure of the time elapsed.

In practice the above method may be implemented through a computer program as described below. The program is made available either on recording media such as a floppy disk or Compact Disk. The program may also be available through a computer network such as the Internet, an intranet, or other network system. When made available over a network the operation of the program and any stored data may be distributed between the user's access device and other network nodes or servers. When the user first accesses the program they are given the ability to declare the one or more pieces of equipment that the program will be used to monitor. Maintenance schedules for the equipment is either loaded from previously prepared files or entered manually. A set of previously prepared files may be made available through the same types of means as the software. The maintenance schedules may be edited by the user to meet a specific need or requirement. The software is then associated with one of the several timing means available through current operating systems. These means may include, for example, the Microsoft Windows® scheduler, a computer interrupt, an autoexec file, or a calendar program such as MS Outlook. The timing means is used to monitor the delay time shown in step 104 of FIG. 1. Once activated, the program will wait for the next scheduled activity. When this activity is due a message may appear on the screen informing the user of the activity that is due. This information may include relevant part numbers or/and ordering information. The user is given the options of acknowledging that the action was done, printing the information, or postponing the information for redisplay at a later time. If the action is said to be done it is removed from the list of items to do. If it is postponed the list of items to do is updated to show a new action time. The action notification may not directly involve the user of the equipment. Alternatively or additionally, the information may be sent directly to other locations such as a purchasing or service department and/or vendor.

Added features that could be included to constitute alternative embodiments are described as follows.

The software may function over a computer network. When doing so multiple instruments possibly distributed over multiple locations may be supported. Information relating to orders, maintenance, parts, supplies, and service may also be accessed or distributed using the network. Data may be stored in a location separate from the instrument being supported. For example, the service schedule, vendor, maintenance history, or part information may be stored on a remote web site or server. This has the advantage that updates could be made at a single point instead of at every instrument. The user, vendor, or other party could update information stored at a remote site. This will allow the parties to make changes to information such as preferred product, inventory, delivery, or price.

There is an advantage to combining multiple items (or services) into a single order. EMWiz may choose to combine items that will be required over a specified period or that will be needed/more convenient for a single service into a single order. EMWiz will use the maintenance schedule to identify items that could be combined and optionally give a user the option of doing so. For example, if two different parts will be required during the next month the user may be offered the opportunity to get them in the same order. In another example, if oil for a pump needs to be changed, a new filter may also be ordered so that both operations can be executed in the same service event. In a third example, oil for pumps in distributed locations or associated with several systems could be combined in a single order.

EMWiz may automatically generate a purchase order (PO) or may place an order on a blanket/open purchase order. This paperwork may be customized to fit a user's specific needs. Using the unique capabilities of EMWiz the PO can include part, vendor, price, and ordering information.

EMWiz may deliver the PO to a printer, computer interface, or alternatively to selected destinations over a computer network. The destination may include vendors, purchasing agents, accounting departments or any other entity to which the information may be of use.

EMWiz may use its unique access to vendor and price information to help track expenses related to the use and maintenance of a piece of equipment. This information may be stored by EMWiz or passed on to another accounting or maintenance program.

EMWiz may choose to place an order from among a list of preferred vendors. This selection may be based on factors such as price and delivery time. Vendor information may be posted or accessed over a computer network.

As an alternative to scheduling events as a function of elapsed time EMWiz is unique in that it may monitor actual instrument activity. This has the advantage that events will be activated as a function of user. In many cases service or the ordering of supplies is more a function of use than of time. For example, single use glass sample vials need to be ordered as a function of their consumption not as a function of time.

In the previous art instrument control systems have monitored instrument usage and warned the user of service requirements for a few items. These systems were limited in a number of ways. For example, they were instrument dependent and limited to a specific data system. They did not generate ordering information. They were not network compatible. They could not work on more than one instrument. And they lacked many other features present in EMWiz.

In embodiments of the invention, instrument activity may be monitored through a number of methods. In the most direct method EMWiz may exchange data directly with a device's control software. Means for doing so are present in many advanced instrument control systems. The advantage of this method is that instrument parameters such as pressure, gas flow, temperature, and background signal may be accessed directly. These factors have direct impact on component lifetime and supplies usage. Other parameters, such as the voltage on a detector, may directly indicate the status of a component.

A simpler method of measuring instrument usage is to monitor the appearance of data files or directories on a computer storage device. This has the advantage that it is independent of interface with the instrument and controlling software. (Note that a function of EMWiz may be the maintenance of data files. After a certain number or size of files are generated EMWiz may facilitate transferring data to an alternative storage device and/or compressing of the data.).

Instrument usage may also be monitored through the use of a physical sensor and the transfer of information from that sensor to the EMWiz program. This may require additional hardware.

Instrument usage may also be entered manually by a user or from data generated by another program. For example, sample tracking, inventory, or barcode reading programs may supply data related to instrument usage.

EMWiz may be integrated with other equipment maintenance or sample processing software packages. For example, “Instrument Maintenance & Calibration System Pro (IMCS™ Pro 2000)” and “Sample Tracking and Inventory System STIS™” offered by ChemSW of Fairfield, Calif.

One of the unique aspects of this invention is ordering and vendor information is combined with a scheduling and instrument maintenance tool. This results in the significant advantage that the information required to order replacement parts is readily available at the time it is needed. The information may include, for example, vendor, price, availability, vendor or service contact information, etc.

Another of the unique aspects is that an order can be placed automatically with little or no added input from the user.

Another unique aspect is that the cost/price information from orders my automatically be used of cost tracking. Information from a large number of instruments may be combined.

Another unique aspect is that maintenance may be scheduled as a function of instrument usage rather than just a fixed time period.

Another unique aspect is that the system may be applied to a wide variety of instruments either jointly or independently. These instruments may have different manufacturers or control software.

Another unique aspect is that the needs of several instruments or a specific time period may be combined in a single order.

Another unique aspect is that service records and cost information may be stored in a way that is accessible over a computer network.

Another unique aspect is that the software may make price (or other parameter) comparisons before placing an order.

Another unique aspect is that the program may include an identifier key that allows the implementation of affiliate and other joint marketing programs.

Another unique aspect of EMWiz is that data files containing service schedules and other data may be distributed independently of the EMWiz program. Several data files may be used with a single system or installation of the program. Data files may apply to one or more specific instruments. The data files may also be distributed with the instrument control software or be provided by service personal. New data files can be developed and existing ones edited through EMWiz's schedule editing features.

Other features of EMWiz include the following.

Data may automatically be loaded from a server to a client through a computer network, the client running EMWiz. For example, in some embodiments a supplier price list is downloaded over the internet.

Instruments may be identified by EMWiz using information contained in instrument control software or hardware.

Vendors can be independent of the instrument manufacturers.

Vendors can be set by provider of the program or provider of the data files.

Data files may be stored on or updated through a computer network.

The program my include, advertisement, useful information, and/or Internet links to vendors or other resources.

The operator of the equipment need not know that an order was placed until, for example, a service person shows up with the parts.

The software may use barcodes or other automated data entry systems to input data.

The software may be used to acknowledge the receipt of product or services.

The software may be integrated with sample tracking software. (Information from such software may be used to track usage.)

The software may generate expense reports. These can include expense/use data. Cost analysis may include data from orders generated.

The software may include provisions to log and manipulate service reports and records.

The vendor may be an online purchasing agent or supplier such as Sciquest.com, Ariba.com, agilent.com, or sisweb.com, or commerceone.com.

The following are illustrative examples intended to show how the invention could be implemented in practice.

### EXAMPLE 1

A vendor wishes to develop business with a large company that has a variety of scientific instruments including mass spectrometers and chromatographs. These systems require regular maintenance, parts to perform maintenance, and consumables. For example, cleaning, filaments, pump oil, filters, columns, septa, glassware, etc.

The vendor supplies the company with a copy of the EMWiz software (an embodiment of the invention). The software is loaded onto the company's servers. At each instrument a service representative links the EMWiz software to the instrument. While doing so the instrument is identified and the appropriate schedule data is downloaded from a web site provided by the vendor.

Instrument usage is monitored through a sample-tracking program and also through the data systems of some instruments. In a specific example a given chromatography column is expected to last for 1000 injections. The sample tracking program tracks the number of injections and, with the appropriate lead-time, EMWiz orders a replacement column from the vendor. The order is automatically passed over the company's computer network from EMWiz software to their purchasing department where it is approved and forwarded by e-mail to the vendor. The vendor ships the product to the user in time for appropriate replacement. The user receives the product with an explanation of why it was ordered. After installation the user tells EMWiz that the service has been completed. The instrument maintenance log is available for documenting GLP and other quality control procedures.

### EXAMPLE 2

A vendor supplies detectors for a specific manufacturer of mass spectrometers. These detectors have a lifetime that is dependent on their use and specific chemicals that they are exposed to. The status of a detector can be indicated by the voltage that it needs to meet a specific performance standard. For example, the mass spectrometer data systems supplied by Agilent Technologies “tunes” the instrument voltages to produce reproducible and optimized instrument performance. When the required detector voltage exceeds a specific value (say 2200 Volts) it is recommended that the detector be replaced.

The vendor provides the EMWiz program to customers who are known to use a specific instrument. The customers install the software, which came with a “schedule” data file that includes information associated with this system. The schedule data includes information that tells EMWiz to watch out for detector voltages above 2200V. When this occurs, EMWiz displays a small pop-up window on the user's computer screen. The text in this window explains the reason for the suggested detector replacement and gives the option of printing ordering information and/or sending an e-mail order to the vendor.

### EXAMPLE 3

A large company uses a large number of pumps in their manufacturing process. They wish to use a web based instrument maintenance & calibration software program. EMWiz is selected because of its unique ability to automatically generate orders. The company installs EMWiz on a single computer in their service center. Options are selected such that the software tracks the pump oil needs of all pumps in the facility. The company enters their own data regarding replacement requirements and preferred vendors into the software. When oil is needed orders are automatically generated and sent electronically to a preferred vendor. When the oil is delivered the packing slip includes information concerning which pumps the oil is to be used in. Periodically the EMWiz software queries a website or other data source managed by a vendor to request a receive updated price information.

### EXAMPLE 4

A medical device (surgical stapler) is used in human surgery. Government guidelines specify that the device may only be used a specific number of times and must be autoclaved between uses. A new set of staples must also be used after each use.

In some embodiments, EMWiz is interfaced to a barcode reader that is attached to the autoclave system. Each time the stapler is placed in the autoclave EMWiz receives the barcode data records a use of the device. The total uses are monitored and, based on use history, an estimated date for replacement is estimated. With sufficient lead-time EMWiz automatically orders a replacement part from a preferred vendor. The cost of the replacement is passed to an accounting group who uses it to help calculate the actual cost of a treatment.

### EXAMPLE 5

EMWiz software is modular. A core executable program is configured to read data from separate data files and to prepare orders. When a user installs the EMWiz software they first identify the various instruments it will be used to monitor. EMWiz then requests, optionally over the internet, specific data concerning those instruments. For example, if a Agilent mass spectrometer of a certain model is to be used then the EMWiz software requests specific maintenance/schedule/interface data for that instrument The request may be made over the internet. Later, when prices change, or a new instrument model is purchased, a new data set can be provided to the EMWiz software. The requested and received data can include maintenance schedule, part numbers, prices, ordering addresses, or the like.

Several embodiments are specifically illustrated and/or described herein. However, it will be appreciated that modifications and variations are covered by the above teachings and within the scope of the appended claims without departing from the spirit and intended scope thereof. For example, the systems and methods described may be used for applications other than scientific or medical instruments.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

For the purposes of this document the terms “maintenance” is meant to include “services” or the ordering of parts or supplies. Likewise, “items” may include physical parts/materials or services. The term “equipment” may indicate a set of equipment or specific items. The terms “instrument”, “equipment”, and “device” are meant to be interchangeable. A “computer network” may include, intranets, internets, or the World Wide Web.

Design suggestions:

In some embodiments, download utility allows user to select several files to be downloaded at once. These will include one executable and 1 or more data files.

In some embodiments, instrument data file is separate. Later we may want to group files in a library so we should plan for forward compatibility. Data files should start with instrument info header. Including version date, model, and manufacturer. In the future we will have to worry about both instrument version and “data system” version. Should include pointer to external file where we can put more information.

In some embodiments, install looks in directory for valid data files and lets users select which should be active with this installation. Install places program in startup directory. Icon placed in icon shelf on start bar. User should be able to disable program.

In some embodiments, the notice window is displayed when scheduled item is due. User has options of “Done”, “Remind in 1 day”, “Remind in 3 days”, or “Print”.

In some embodiments, the notice window will display scheduled item, any required part numbers, and order information. We may want to include a source id in the P/N so we can support an affiliate program later.

In some embodiments, every 90 days a notice is displayed to update the software. This should include planned new features. Do we want to force update after 1 year?

Optionally include rotating list of advertisements within the software program interface.

Optionally include encrypted protection so that another company cannot substitute their data without permission. This is important for P/N and ordering information. Spacer 540 is optionally shared by a plurality of Membrane Switch 500.

In some embodiments, during installation or at the first time the program is executed the user will need to indicate when operations to be scheduled were last done.

What is claimed is:

1. A method of generating orders comprising:
reading a data from a data acquisition system;
reading an action associated with the use of an instrument;
comparing the action with the data;
taking the action;
generating an order based on the action;
displaying the action; and
updating a record that the action has been taken.

2. A driver's license comprising:
an antenna configured to receive a first wireless signal from an RF transmitter;
a power circuit configured to convert the first wireless signal into electronic power;
a circuit configured to receive the electronic power and to send a second wireless signal in response to the first wireless signal; and
a first membrane switch configured to control operation of the circuit under control of a user.

3. A device comprising:
one or more switches configured to control one or more passive RFID tags; and
at least one antenna configured for the one or more passive RFID tags to send an RF signal.

4. The device of claim 3, wherein the device includes a financial card.

5. The device of claim 3, wherein one of the one or more switches is a membrane switch.

6. The device of claim 3, wherein one of the one or more passive RFID tags is replaceable.
